(19) United States
(12) Patent Application Publication
(10) Pub. No.: US 2026/0204099 A1
(43) Pub. Date: Jul. 16, 2026

(54) SYSTEM AND METHOD OF DETERMINING GAME PLAY

(71) Applicant: Michael Kleinpeter, Savannah, GA (US)

(72) Inventor: Michael Kleinpeter, Savannah, GA (US)

(21) Appl. No.: 19/021,804

(22) Filed: Jan. 15, 2025

(51) Int. Cl. G06V 40/20; G06V 10/82; G06V 20/40

(52) U.S. Cl. CPC G06V 40/23; G06V 10/82; G06V 20/42

(57) ABSTRACT

One embodiment of the disclosure provides a system and a method of determining game play including identifying at least one player on a game play space, determining, the movement of the at least one player on the game play space, analyzing, utilizing an artificial intelligence algorithm, the determined movement of the at least one player on the game play space, determining, based on the analyzing, the at least one player game play on the game play space, outputting, the at least one player game play to a device.

### BACKGROUND

### Field of the Invention

The present disclosure is directed to a system and method of identifying players on a game play space utilizing artificial intelligence to determine information about the game play.

### Description of the Related Art

In 2023 a record number of people, approximately 115 million, watched the super bowl football game. These viewers watched the game on televisions, mobile phones, and other computing devices. This trend of increasing viewership of professional sports is also apparent in sports other than football as well. However, traditional methods of viewing game play is linear and inefficient, requires significant memory of computing devices and significant bandwidth i.e., cellular/mobile, fiber, cable, wireless etc. Increased viewership has resulted in playback error and network failure. Significant network bandwidth demand and strain on computing resources was the reason for the failed network airing and playback errors observed in the recent Netflix™ fight between Jake Paul vs. Mike Tyson. What is needed is a system and method that provides error-free real-time play and playback, requires low-bandwidth to transmit to a user, and decreased memory consumption and processor cycle times on computing devices and provides efficient viewing of following a game in both a non-linear and linear fashion.

### SUMMARY

In one embodiment of the present disclosure, a system and method is provided that utilizing one or more artificial intelligence algorithm identifies players on a game play space, determines the players movements on the game play space, analyzes the movement, determines, based on the analysis, the players game play on the game play space and then outputs the players game play to a device. The systems and methods provided herein may utilize computer vision models, large language models and/or artificial intelligence algorithms to determine game play of players on a game space. In one embodiment, the system and method of the disclosure provide an efficient means of data collection by multiple data sources, analyzes game play in real-time with at least one artificial intelligence algorithm(s), combining this information and outputting that information in a linear and/or non-linear manner to a user that reduces network failure and improves performance of the computing device.

### BRIEF DESCRIPTION OF THE DRAWINGS

FIG. 1 is a perspective view of game play space and game play collection devices mounted above a game play space according to one embodiment of the disclosure.

FIG. 2 is a perspective view of players in a first position on a game play space according to one embodiment of the disclosure.

FIG. 3 is a perspective view of a trace of a players movement on a game play space according to one embodiment of the disclosure.

FIG. 4 is a perspective view of players in a second position on a game play space according to one embodiment of the disclosure.

FIG. 5 is a perspective view of identified players and identified referees on a game play space according to one embodiment of the disclosure.

FIG. 6 is a diagram of a computing device according to one embodiment of the disclosure.

FIG. 7 is a diagram of an artificial intelligence module according to one embodiment of the disclosure.

FIG. 8 is a flowchart of a method of determining play on a game play space according to one embodiment of the disclosure.

FIG. 9 is a view of a graphical user interface of an application populated with information determined about the play on a game play space displayed on a user computing device according to one embodiment of the disclosure.

### DETAILED DESCRIPTION

In some embodiments, and for purposes of illustrating the current disclosure the system and method will be described with reference to a game of North American football but the disclosure is not limited as such, and a person skilled in the art of practicing the invention will recognize that the system and method of the disclosure may be carried out on any type of game where players play on a game play space, i.e., basketball, tennis, pickleball, volleyball, soccer, baseball or any combination thereof.

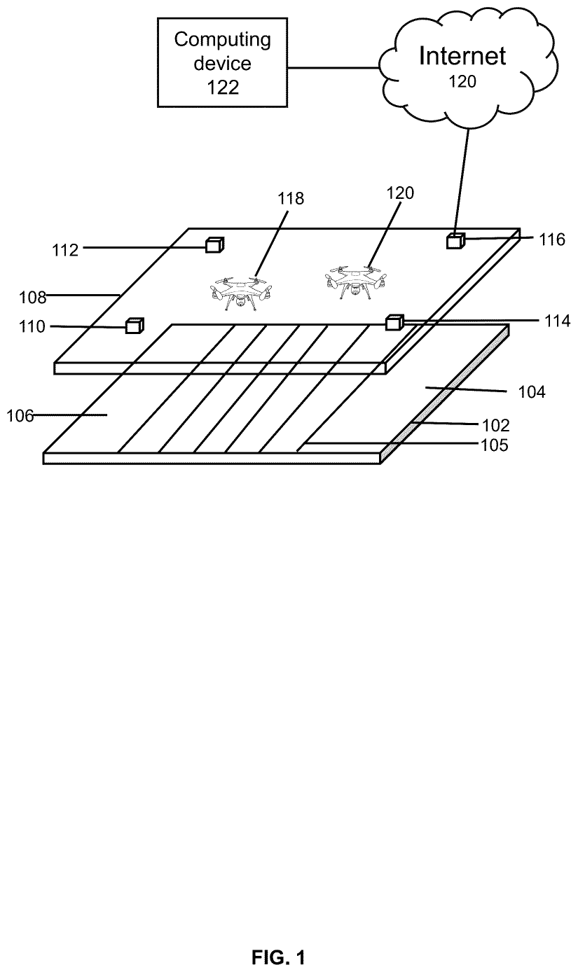

FIG. 1 is a perspective view of game play space and game play collection devices mounted above a game play space according to one embodiment of the disclosure. In some embodiments the game play space 102 may be a rectangular field having a number of markers 105 that denote a position of play on the game play space 102. The game play space 102 may have goal 104 and goal 105 at opposing ends of the rectangular field, to which, members of each team advance the game play in order to score points.

In some embodiments the game play space 102 may have a plurality of game play detection device(s) positioned, fixed and/or freely moving, above the game play space 102. In some embodiments the game play detection device(s) may be configured as an image device, capable of capturing an image of the game play space 102. In some embodiments, a plurality of game play detection device(s) may be utilized to capture images, and/or a series of images (i.e., video). In some embodiments an image device may be configured as a device capable of capturing video and/or images in a plurality of visible and non-visible light spectrums i.e., infrared spectrum, ultraviolet spectrum, or any spectrum that enables the system and method of the disclosure to determine game play on the game play space 102. In some embodiments a game play detection device(s) may be configured to detect and capture a plurality of audio signals. In some embodiments a game play detection device(s) may be configured as a device at any altitude above a game play space such as a drone, a blimp, an airplane, and/or a device orbiting earth in low earth orbit or in space such as a satellite device. A game play detection device(s) may be a device configured to operate in a cellular bandwidth, and/or a device configured to operate in a Bluetooth™ bandwidth.

In some embodiments game play detection device(s) may be attached to suspended system 108 in a configuration such as game play detection device 110, game play detection device 112, game play detection device 114, and game play detection device 116. The system and method of the disclosure are not limited to any number of game play detection device(s), and the game play detection device(s) may be positioned at any point on the suspended system 108 and/or at any point on and/or near the game play space 102 including parallel to the game play space 102, and/or mounted in the game play space 102, game play detection device(s) may be mounted to cables suspended above a game play space 102 and capable of moving along said cables as players move within the game play space 102 or any combination thereof. In some embodiments, a game play detection device(s) may be configured as a drone 118, drone 120 and/or a plurality of drones configured with an image capture device and/or video capture device, and/or audio signal capture device capable of capturing game play on a game play space 102.

In some embodiments, game play detection device 110, game play detection device 112, game play detection device 114, and game play detection device 116, may be configured with audio signal detection equipment to detect audio signals that occur in and around the game play space 102. For example, the audio signal detection equipment may collect audio signals of game play officials such as referees, commentators, players, coaches, audience members, and/or any audio source near or around the game play space 102. In some embodiments, the system and method of the disclosure may be configured to directly receive audio signals from an audio feed of a PA system of the game play space 102 (not shown).

In some embodiments, game play detection device(s) may be connected to the internet 120 and may be connected to computing device(s) 122. Processing of data from game play detection device(s) may be carried out in applications stored on the internet 120 and/or the computing device(s) 122, and/or may be processed partially and/or entirely locally by a computing system(s). Game play detection device(s) may include a plurality devices attached and/or affixed to players such as for example electronic devices capable of transmitting and receiving signals such as a global positioning system device GPS or Bluetooth™ device and/or camera capable of collecting images and video footage of a game and audio signals. In some embodiments game play detection device(s) may operate in a cellular or mobile phone transmission range such as 3G, 4G, 5G, 6G, 7G, 8G, 9G, 10G and/or any transmission range capable of transmitting and receiving a cellular signal in a cellular bandwidth. In some embodiments, a game play detection device(s) attached to or affixed to a player may include a device capable of transmitting and/or receiving signals from a satellite and/or low earth orbit device. In some embodiments any combination of the aforementioned devices may be utilized to detect information related to game play on the game play space 102 to be analyzed by the system and method disclosed herein.

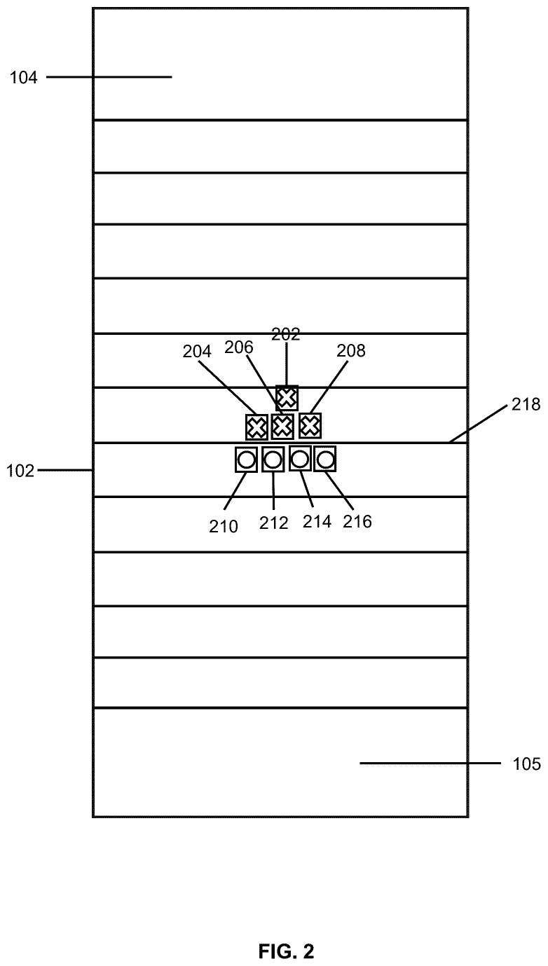

FIG. 2 is a perspective view of players in a first position above the game play space according to one embodiment of the disclosure. In some embodiments, the system and method may be configured to identify players on a game play space 102 viewed from a position above the game play space 102. The game play space 102 may have goal 104 and goal 105 configured at opposing ends of the space, players, positioned at marker 218, line up to engage in game play.

In some embodiments, the system and method may be configured to utilize a game play detection device(s) to identify players on the game play space 102. In some embodiments the system and method may utilize an artificial intelligence module having one or more artificial intelligence engines that are configured to identify players, determine movements of players, analyze the movement of players, and determine a state of play. In some embodiments, the system and method may be configured to analyze images with one or more artificial intelligence algorithm(s) to identify players on the game play space 102. In some embodiments, the system and method may utilize at least one object detection algorithm from the following algorithms but is not limited to utilizing one or more of the algorithms and may utilize object detection and tracking algorithms to identify players other than or in combination with YOLO (real-time object detection), SSD (single shot detection) RetinaNet (focal loss detection), Faster R-CNN (two-stage detection), Mask R-CNN (instance segmentation), Cascade R-CNN (progressive refinement), Focal Loss (dense object detection), MobileNetV2 (efficient mobile detection), Single Shot MultiBox Detector (real-time multi-scale detection), YOLOv3 (incremental improvement), YOLO 9000, Mobile Nets, YOLOv4. In some embodiments, the system and method utilizing an artificial intelligence object detection algorithm, may detect and utilize bounding boxes around player 202, player 204, player 206, and player 208, on a game play space 102. In some embodiments, one or more of the artificial intelligence algorithms utilized by the system and method may be trained to identify players, determine movements of players, and analyze player movements to determine a play state of the game by training the AI algorithms on labeled data of images from a game play on a game play space 102. For example, a labeled images could include images of players on a field, the label may read i.e., “tight end”, “linebacker”, “quarterback”, the trained AI algorithm receiving images from a game play detection device(s) may, in real-time, determine which position a player is playing on a game play space 102. In some embodiments, one or more of the aforementioned artificial intelligence algorithms can be further trained to determine movements of players by training the AI algorithms on images of labeled play data from a game play on a game play space, and can further be trained to analyze and determine a game play statistic from completed play labeled data of game play in a game play space 102.

In some embodiments, the system and method may be configured to utilize an artificial intelligence algorithm to identify additional information about player 202, player 204, player 206, and player 208, on a game play space 102 such as for example, player 202 is in a position of quarterback and is in a position of receiving a ball from player 206. Player 206 is in a position of center, and is flanked on either side by player 204 and player 208 in a blocking position.

In some embodiments, the system and method utilizing a trained artificial intelligence algorithm may identify additional information about player 210, player 212, player 214, and player 216, on a game play space 102 such as for example, player 210, player 212, player 214, and player 216 are in a defensive position and are aligned on marker 218. Player 210, player 212, player 214, and player 216 are aligned in an opposing position with player 204, player 206, and player 108.

In some embodiments the system and method utilizing one or more trained artificial intelligence algorithm(s) may be configured to determine a play state of game play such as for example, if zero seconds have elapsed in the game, then the offensive team, player 202, player 204, player 206, and player 208 has possession at first down and ten yards. Alternatively, in some embodiments the system and methods may utilize a rules-based system for keeping track of the state of play on game play space 102. For example, if zero seconds have elapsed in the game, then the offensive team including player 202, player 204, player 206, and player 208 has possession at first down with ten yards to complete a first possession.

In some embodiments, the system and method may be configured to utilize both a rules-based system and at least one trained artificial intelligence based system to determine a state of play on a game play space 102. The system and method may further be configured to utilize audio signals collected from game play detection device(s) and utilize an artificial intelligence algorithm, for example, an LLM may be utilized to analyze audio signals to determine a state of play on the game play space 102. For example, an LLM may be trained to identify audio signals from a game play referee such as “player 202 was sacked at the line of scrimmage, second down”.

In some embodiments, the system and method may be configured convert a determined game play prediction from image analysis to a semantic vector and then compare a semantic vector predicted from an LLM of game play audio signals collected from game play detection device(s) to improve the accuracy of determined game play on a game play space 102. For example, the system and method utilizing an artificial intelligence algorithm to analyze images collected from game play detection device(s) may determine from the images that player 214 tackled player 202, and 4.6 seconds elapsed, on a first down. The system and method may be configured to convert these values to numerical vectors and utilize an algorithm to compare them such as cosine similarity, k-nearest neighbor, clustering, and/or other algorithm such as hierarchical navigable small world (HNSW), ScaNN (Scalable Nearest Neighbors), or any combination thereof.

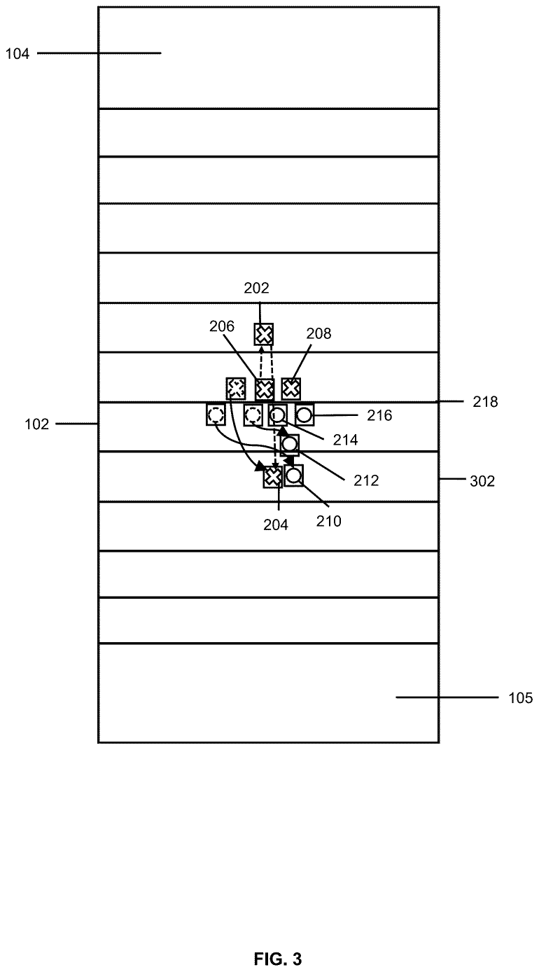

FIG. 3 is a perspective view showing players movement on the game play space according to one embodiment of the disclosure. In the embodiment of FIG. 3 the system and method determine the movement of a player on the game play space 102, and that movement is denoted as solid line X and O which indicate a position of a player, and a dashed line X or O indicate a determined starting position, the solid arrows indicate determined movement path of a player, and dashed lines indicate a determined movement path of the ball.

In some embodiments the system and method may be configured to identify players on a game play space 102 and may be configured to utilize images collected from game play detection device(s) to identify players on a game play space 102 (as discussed in the aforementioned paragraphs). The system and method may utilize one or more aforementioned trained artificial intelligence algorithms to determine from a series of images collected from game play detection device(s) that player 202, player 204, player 206, player 208, player 210, player 212, and player 214 are on game play space 102.

In some embodiments and in FIG. 3 the system and method utilizing at least one trained artificial intelligence algorithm may determine a first movement of the ball denoted by the dashed line with the arrow to player 202 (the quarterback) from player 206 (center). A movement forward by player 204 toward goal 105, denoted by dashed line X position of player 204 and solid line arrow to a new position down field (solid line X player 204), movement backward by player 212, previous position denoted by dashed line circle, to new position (solid line circle player 212) at new position, movement backward by player 210 denoted by dashed line circle player 210 at previous position and arrow to new position of player 210 (solid line circle player 210), final ball position denoted by the dashed arrow from player 202 to player 204 and the system and method determines a new position of play indicated by marker 302.

In some embodiments the system and method may utilize multiple sources of images from game play detection device(s) to determine a movement of players on a game play space 102 for example the system and method may collect image and audio feeds from game play detection device 110, game play detection device 112, game play detection device 114, game play detection device 116, and utilize one or more of the aforementioned artificial intelligence algorithms to process each image and/or audio feeds to determine a player movement on the game play space 102.

In some embodiments the system and method of the disclosure is capable of performing real-time analysis of a plurality of image and/or audio feeds simultaneously so for example, if the final position of player 204 is blocked in the image feed from game play detection device 116, because player 210 is between the image feed from game play detection device 116 and player 204, then the system and method may determine the position of player 204 may be determined by game play detection device 214 which is positioned at an angle where the image feed is not blocked by player 210.

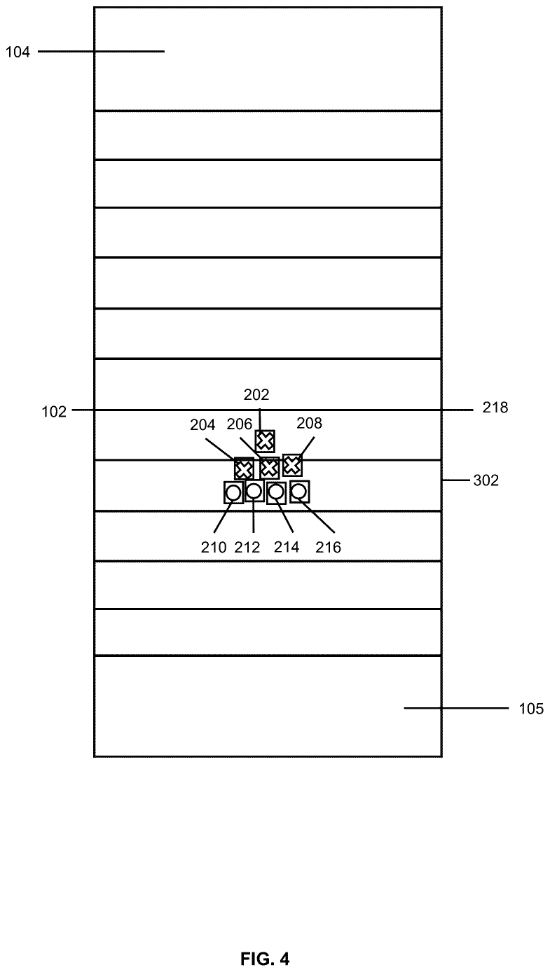

FIG. 4 is a perspective view of players in a second position on a game play space according to one embodiment of the disclosure. In some embodiments, the system and method may be configured to analyze the determined movement of players utilizing one or more of the aforementioned artificial intelligence algorithms to determine game player play on a game play space 102. Game player play analysis may include determining a plurality of game player statistics such as for example, the analysis may determine that in the previous play, player 202 threw a complete pass, that player 204 received the pass, player 210 tackled player 204, player 205, and player 208 blocked player 214, and player 215.

In one embodiment in FIG. 4 the game player play analysis may determine a current state of the game as play on the game play space 102 was advanced by 7 yards, and the current state of the game is 2nd down and 3 yards to go, the current position of play is at marker 302. In FIG. 4 player 202, player 204, player 206, player 208 have advanced to a new position at marker 302, and on the opposing team, player 210, player 212, player 214, and player 216 have advanced to a new position at marker 302 to oppose the advance to goal 105.

In some embodiments, the player game play statistics determined by the system and method may be sent to an application operating on a user computing device such as for example a mobile phone, a smartwatch, a tablet, a laptop computer, a desktop computer, and/or any computing device capable of receiving data through a wired and/or wireless network.

In some embodiments, the player game play determined by the system and method may be converted to audio signal and broadcast in an electromagnetic wave spectrum of 3 hertz to 3,000 gigahertz, a range of radio wave spectrum for broadcasting radio waves. The broadcast signal may be received by a user device capable of receiving radio signals.

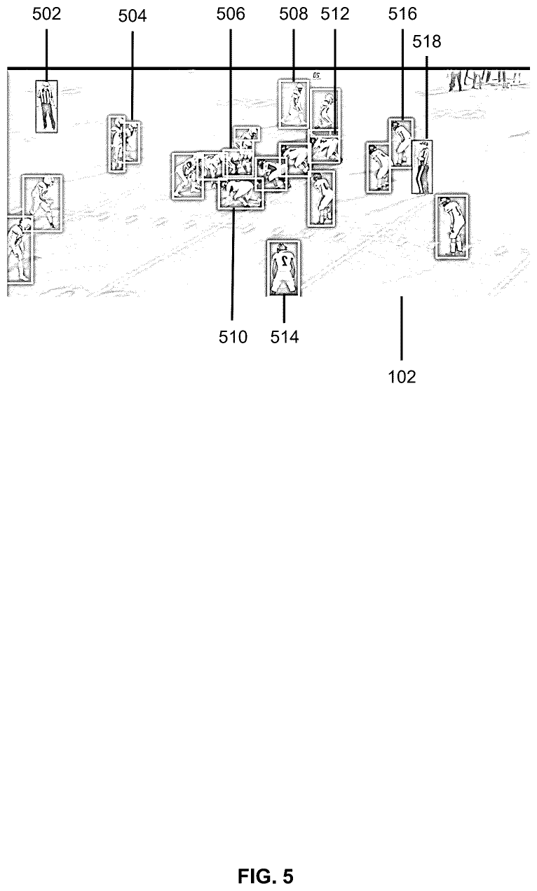

FIG. 5 is a perspective view of identified players and identified referees on a game play space 102 according to one embodiment of the disclosure. In some embodiments the system and method of the disclosure may utilize one or more CNN artificial intelligence algorithms that may have architecture similar to the YOLO algorithm as the YOLO architecture optimizes for solving object detection utilizing regression rather than classification. This is accomplished by spatially separating bounding boxes and associating probabilities to each detected image using a single convolutional neural network (CNN).

In some embodiments, utilizing an object detection algorithm such as YOLO as shown in FIG. 5 the system and methods of the disclosure are capable of accurate object detection, and drawing bounding boxes around player 504, player 506, player 508, player 510, player 512, player 514, player 516, referee 501, and referee 518 in a game play space 102 at a rate of up to 45 frames per second. In some embodiments the selected algorithm may be capable of accurate object detection, identification, determining movement, analyzing movement, and determining game play in real-time may be in a range of frames per second such as 0-10, 10-20, 20-30, 30-40, 40-50, 50-60, 60-70, 70-80, and in some instances up to and/or more than 90 frames per second.

In some embodiments, optimal architecture of an AI algorithm for identifying a player, determining a movement of a player, analyzing the movement of a player and determining game play of a player may be configured as an input layer, a convolutional layer having more than and/or less than 24 layers, more and/or less than 4 global max pooling function layers, at least one fully connected layer(s) and an output layer. In some embodiments, an optimal architecture of an algorithm may be configured with a global max pooling layer in a range of 1-2, 2-3, 3-4, 4-5, 5-6, 6-7, 7-8, 8-9, 9-10, 10 and/or more layers, or any combination thereof.

In some embodiments, an AI algorithm utilized by the system and method such as the aforementioned CNN may be configured to receive data input from a game play detection device(s), the system and method may be configured to optimize processing by the algorithm by resizing an input image into a range of 224×224, 448×448, 896×896, 1024×1024 pixel size prior to operations performed by the convolutional layer(s).

In some embodiments, the system and methods may further optimize processing by the algorithm by reducing the number of channels by applying a 1×1 convolution, the system and method may then be configured to apply a 3×3 convolution to generate a cuboidal output. In some embodiments, the algorithm may utilize a ReLU activation function in any of the convolution layers, the final layer, which may utilize a linear activation function. Furthermore, the algorithm is not limited to the aforementioned architecture, and may be further configured to utilize techniques such as batch normalization and dropout, to regularize the model and prevent it from overfitting.

In some embodiments, the system and method may identify players on a game play space 102 as shown in FIG. 5 by utilizing one or more of the aforementioned trained artificial intelligence algorithms. The system and method may identify players on a game play space 102, and further identify their role based on their position and/or uniform in the game such as for example player 502 (referee), player 504 (quarterback), player 506 (center), player 508 (running back), player 510 (defensive end) player 512 (defensive end), player 514 player (free safety) 516 player (outside linebacker) 518 (referee). The system and method may be capable of identifying all players and a game player's role on a game play space 102 and is not limited to only identifying the aforementioned players.

In some embodiments, the system and method may be capable of utilizing one or more of the aforementioned trained artificial intelligence algorithms to determine a movement of player 502 (referee), player 504 (quarterback), player 506 (center), player 508 (running back), player 510 (defensive end) player 512 (defensive end), player 514 (free safety) player 516 (outside linebacker) 518 (referee) from images received from the game play detection device(s).

In some embodiments the system and method may be capable of utilizing one or more of the aforementioned trained artificial intelligence algorithms to analyze the game play and determine a game play statistic from the analysis of the determined movement. For example, the system and method may determine that player 504 threw a complete pass, that player 508 received the pass, player 516 tackled player 508, player 510, and player 512 blocked player 506, and that game play was advanced by 7 yards, and the current state of the game is 2nd down and 3 yards to go. In some embodiments, the system and method may be configured to send the determined game play statistics to a computing device of a user.

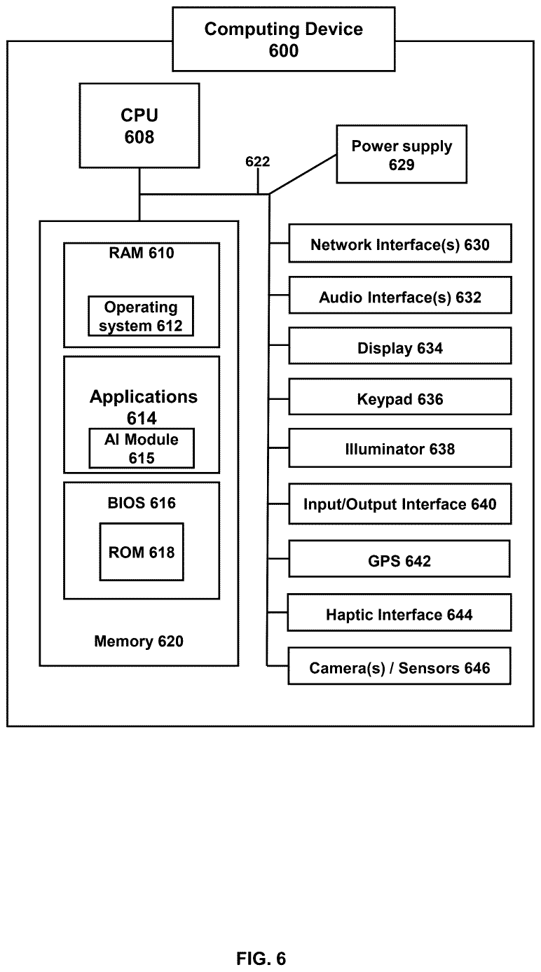

FIG. 6 is a diagram of a computing device according to one embodiment of the disclosure. In some embodiments, as shown in FIG. 2 the computing device may be used within the present disclosure. The system and method of the disclosure can include many more and/or fewer components than those shown in FIG. 6. However, the components shown are sufficient to disclose an illustrative embodiment for implementing some aspects of the present disclosure, and the computing device 600 can represent any one or more of the servers and/or client devices as discussed in the aforementioned paragraphs.

In some embodiments, the computing device 600 may include a processing unit CPU 608 in communication with a mass memory 620 via a bus 622. CPU 608 may be configured as a specialized processor, such as an application specific integrated circuit (ASIC) and/or a graphics processing unit (GPU). Computing device 600 also includes power supply 629, one or more network interfaces 630, an audio interface 632, display 634, keypad 636, illuminator 638, an input/output interface 640, global positioning system GPS 642, haptic interface 644, camera(s)/sensor(s) 646.

Computing device 600 may also include a rechargeable and/or non-rechargeable battery (not shown) that provides power to the computing device 600, power may also be provided by an external power supply such as an AC adapter, and/or a docking cradle that is capable of being connected to an external AC power source.

Computing device 600 may also communicate with a base station (not shown) or may communicate directly with another computing device. Computing device 600 can include the network interface 630 that includes circuitry capable of coupling computing device 600 to one or more networks, and is capable of utilizing one or more communication protocols and technologies as discussed in the present disclosure. Network interface 630 is sometimes known as network interface card (NIC) or network transceiver. Input/output interface 640 is capable of utilizing one or more communication technologies such as USB, infrared ports, Bluetooth™ or the like.

Computing device 600 includes mass memory 620 and also includes RAM 610 and ROM 618. The mass memory 620 is capable of storing computer readable instructions, which store thereon information in the form of software code, the software code can include data structures, program modules or other data. Mass memory 620 may also store basic input/output system BIOS 616 for controlling low-level operations on the computing device 600. Mass memory 620 is also capable of storing an operating system 612 in RAM 610 for controlling the operation of the computing device 600. The operating system 612 can include a general purpose operating system such as UNIX or LINUX™ or specialized operating system. Operating system 612 can include or interface with a Java virtual machine module and/or operating system operations via Java applications programs.

Mass memory 620 also stores applications 614 and may also store one or more artificial intelligence (AI) module(s) 615, and may include one or more data stores that may be utilized by applications 614 or AI module 615. AI module 615 may include one or more AI engines capable of executing one or more of the artificial intelligence algorithms stored in AI module 615 and may analyze data collected from the system and method of the disclosure. Applications 614 may also include computer executable instructions that can be executed by computing device 600 or any other computing device accessible to computing device 600 through network interface(s) 630 and transmit receive, and/or otherwise process text, audio, video, images or enable telecommunication with other servers such as for example a cloud computing device (not shown) and/or another client device such as for example a mobile computing device, portable computing device such as a laptop or a desktop computer. Applications 614 may for example be programs or “apps” and some embodiments may be database programs, word processing programs, search programs, task managers, contact managers, calenders, browsers, transcoders, security applications, spreadsheet programs, games, and so forth.

Computing device 600 may be one of the computing device(s) 122 shown in FIG. 1 and can include a processor, a non-transitory computer-readable storage medium for tangibly storing thereon program logic for execution by the processor, the program logic having executable code for executing at least some of the steps of a method disclosed herein. For example, program logic may have executable code for generating a graphical user interface, and executable code for outputting game play statistics to the GUI of a user computing device. Computing device 600 may include program logic for retrieving, at the request of a user from a GUI operating on a user computing device, an image and/or a series of images (video) from game play that is related to a game play statistic sent to a GUI operating on the user computing device.

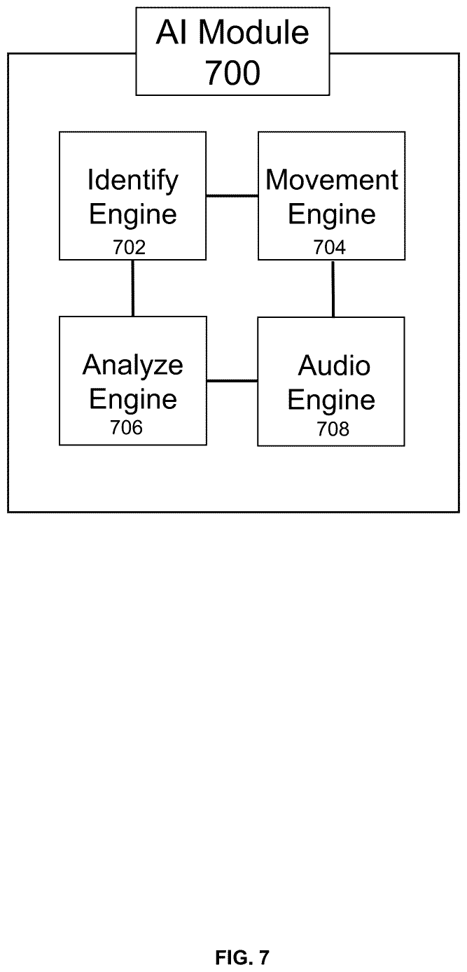

FIG. 7 is a diagram of an artificial intelligence module according to one embodiment of the disclosure. In some embodiments mass memory 620 may include artificial intelligence (AI) module 700. AI module 700 may have one or more artificial intelligence engines, each engine trained on labeled data from images of game play and capable of performing analysis of images collected from game play detection device(s) utilizing one or more trained artificial intelligence algorithms such as YOLO (real-time object detection), SSD (single shot detection) RetinaNet (focal loss detection), Faster R-CNN (two-stage detection), Mask R-CNN (instance segmentation), Cascade R-CNN (progressive refinement), Focal Loss (dense object detection), MobileNetV2 (efficient mobile detection), Single Shot MultiBox Detector (real-time multi-scale detection), YOLOv3 (incremental improvement), YOLO 9000, Mobile Nets, YOLOv4 or any combination thereof. In some embodiments, the system and methods may utilize statistical measures for identifying, determining movement, movement analysis of determined movement such as intersection over union (IOU), precision and recall, average precision, mean average precision, F1 score, or any combination thereof for determining game play of a player.

In some embodiments, training of engines on the AI module 700 may be carried out in the following manner. AI module 700 may include identify engine 702, movement engine 704, analyze engine 706, and output engine 708. In some embodiments, each of the engines of AI module 700 may utilize one or more of the aforementioned artificial intelligence engines to carry out a specific task or function, for example, identify engine 702 may utilize YOLO (real-time object detection) to identify players on a game play space 102. Identify engine 702 utilizing YOLO may be trained on curated (hand-labeled) data of images of a football game such as an image showing a player with an identifiable feature such as a jersey number and/or number on a helmet and/or other identifier. The subsequent labelling by a human may be utilized to train a YOLO algorithm to identify a jersey number or a helmet number on an identified player.

In some embodiments, identify engine 702 may receive images and/or a series of images from game play detection device(s), and utilize one or more of the aforementioned AI algorithms to identify players in a game play space 102. The system and method may utilize a statistical measure for example, in a first stream the identify engine 702 may identify player 202 at a 56% probability, and in a second stream from a second game play detection device(s), identify engine 702 may identify player 202 at an 88% probability. In some embodiments, one or more streams of images from game play detection device(s) may be collected and sent to one or more computing devices 600 including one or more identify engines 702 that subsequently identify players in a game play space 102 independently. The system and method may utilize one or more of those streams to, in real-time, identify players in a game play space 102.

In some embodiments, movement engine 704 may be trained to determine movement of players that have been identified by identify engine 702. In some embodiments, movement engine 704 may be trained in a paradigm similar to identify engine 702. Movement engine 704 may be trained on hand curated (human labeled) labeled data of a series of images depicting plays performed by players in a football game, for example a series of training epochs may include a human labeled data set of a first movement of a ball to player 202 (the quarterback) from player 206 (center), a movement forward by player 204 toward goal 105, movement backward toward goal 105 by player 212, movement backward by player 210 toward goal 105 final ball position to player 204 at marker 302. This labeled data set may be used to train movement engine 704 utilizing one or more of the aforementioned artificial intelligence algorithms to determine a movement of the players on a game play space 102.

In some embodiments, movement engine 704, having been trained as per described above may receive images and/or a series of images from game play detection device(s), and utilize one or more of the aforementioned AI algorithms to determine a movement of the identified player in a game play space 102. In some embodiments, one or more streams of images from game play detection device(s) may be collected and sent to one or more computing devices 600 including one or more movement engines 704 that subsequently determine a probability based on the data received for example a movement engine 704 may determine a movement of players with a 44% probability from a first image feed from a game play detection device(s), while a second movement engine 704 that receives data from a second game play detection device(s) may determine a movement of players with a 94% probability. The system and method may utilize the determined movement having a higher probability. The system and method may utilize one or more of those streams to, in real-time, determine the movement of the identified players in a game play space 102.

In some embodiments, analyze engine 706 may be trained to analyze the determined movement of players that have a determined movement by movement engine 704. In some embodiments, analyze engine 706 may be trained in a paradigm similar to movement engine 704. Analyze engine 706 may be trained on hand curated (human labeled) labeled data of a series of determined movements in images depicting plays performed by players in a football game, for example a series of training epochs may include a human labeled data set of a first movement of a ball to player 202 (the quarterback) from player 206 (center), a movement forward by player 204 toward goal 105, movement backward toward goal 105 by player 212, movement backward by player 210 toward goal 105 final ball position to player 204 at marker 302.

In this training epoch, the labeled data indicate that player 202 completed a pass to player 204, and advanced the ball 7 yards, player 210 tackled player 204 at marker 302, and the next play is 2nd down and 3 yards to go. This labeled data set can be used to train analyze engine 706 utilizing one or more of the aforementioned artificial intelligence algorithms to analyze the determined movement of the players on a game play space 102 and determine a game play statistic of players during the game play.

In some embodiments, audio engine 708 may be configured with a large language model (LLM) that utilizes one or more artificial intelligence models such as for example ChatGPT, Claude, MosaicML65B or the like to determine a statistic of game play on a game play space 102 from audio signals collected from one or more game play detection device(s).

In some embodiments, training of audio engine 708 may be performed in a similar manner as described in the disclosure such as for example, one or more of the LLM models may be trained on audio signals recorded from football games. The trained audio engine 708 may be configured to receive one or more audio signals from a game play detection device(s) and utilize one or more of the aforementioned LLM models to determine a game play statistic from the audio signal.

In some embodiments, computing device 600 may be configured to utilize the output of the analyze engine 706 and the output of audio engine 708 to perform an output analysis, for example the output may be compared as an error check and/or fact check. In some embodiments an output of from analyze engine 706 may be “player 202 passed the ball to player 204, player 210 tackled player 204, seven-yard pass completed, 2^{nd} down”, and an output from audio engine 708 may be “player 204 receives the pass for a seven yard gain”. In some embodiments, computing device 600 may be configured to compare these outputs utilizing a distance measure such as k-means algorithm, a clustering algorithm, or a similar algorithm that may determine the similarity of a numerically transformed vector of the outputs.

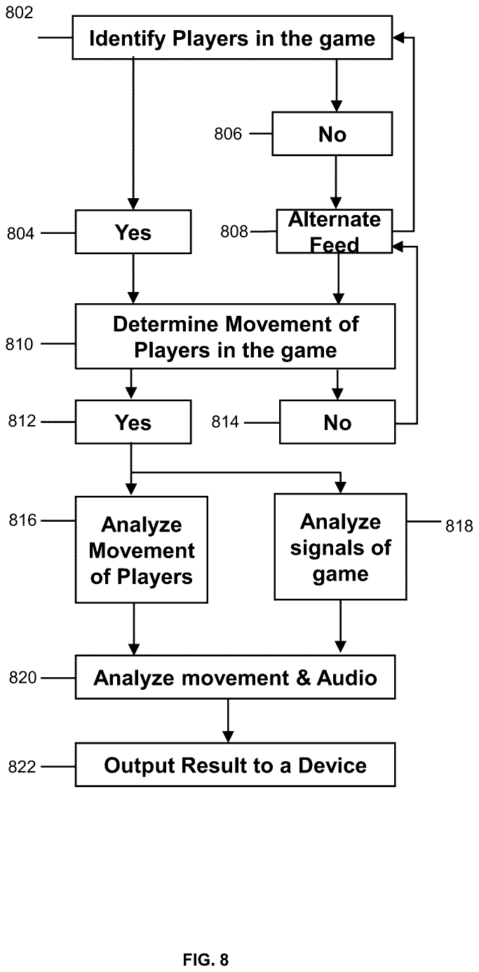

FIG. 8 is a flowchart of a method of determining play on a game play space according to one embodiment of the disclosure. In some embodiments, at Step 802 the method identifies players on a game play space 102 utilizing one or more images and/or image feeds collected from a game play detection device(s). In some embodiments the method at Step 802 utilizes one or more trained artificial intelligence algorithms to analyze the images such as for example, YOLO (real-time object detection), SSD (single shot detection) RetinaNet (focal loss detection), Faster R-CNN (two-stage detection), Mask R-CNN (instance segmentation), Cascade R-CNN (progressive refinement), Focal Loss (dense object detection), MobileNetV2 (efficient mobile detection), Single Shot MultiBox Detector (real-time multi-scale detection), YOLOv3 (incremental improvement), YOLO 9000, Mobile Nets, YOLOv4 or any combination thereof.

In some embodiments the method at Step 804 may then determine if all players are identified in the game play space 102. In some embodiments the game play detection device(s) such as game play detection device 110, game play detection device 112, game play detection device 114, collects multiple feeds of images, audio, and other signals simultaneously. The method at Step 804 may be capable of utilizing multiple computing devices 600 that utilize the aforementioned trained artificial intelligence algorithms to identify players in each of these feeds in real time, and determine which game play detection device(s) feed to utilize for further analysis based on how many players are identified in the feed for example the method may identify only 10 of 11 players in game play detection device 112 then the method at Step 806 has not identified all players in the game, and the method at Step 808 attempts to identify all the players in an alternate feed.

In some embodiments at Step 804 the method identifies all 11 players within one or more game play detection device(s) utilizing one or more of the aforementioned artificial intelligence algorithms. In some embodiments the method at Step 810 analyzes images with one or more artificial intelligence algorithm(s) to identify players on the game play space 102. In some embodiments, the method may utilize a trained object detection and tracking algorithms to determine the movements of the identified players with YOLO (real-time object detection), SSD (single shot detection) RetinaNet (focal loss detection), Faster R-CNN (two-stage detection), Mask R-CNN (instance segmentation), Cascade R-CNN (progressive refinement), Focal Loss (dense object detection), MobileNetV2 (efficient mobile detection), Single Shot MultiBox Detector (real-time multi-scale detection), YOLOv3 (incremental improvement), YOLO 9000, Mobile Nets, YOLOv4.

In some embodiments, if the method at Step 814 is not able to determine movements of the players in the game, the method returns to Step 808 to determine the movement of the player in an alternate feed or alternate source of data. In some embodiments at Step 812, the method determines the movement of all 11 players in the game on the game play space 102 from data from an alternate feed/data source of a game play detection device(s).

In some embodiments the method at Step 816 utilizes one or more of the aforementioned trained artificial intelligence algorithms to analyze the determined movement of players in a game play space 102 and determine the players game play. The algorithm may for example determine based on the analysis that player 202 completed a pass to player 204, and advanced the ball 7 yards, player 210 tackled player 204 at marker 302, and the next play is 2nd down and 3 yards to go (shown in FIG. 2).

In some embodiments, the method at Step 818 may analyze alternative signals of the game. In some embodiments, the method may utilize a trained LLM to analyze audio signals collected from the game, for example, the LLM trained to analyze audio signals to determine a state of play on the game play space 102 may be trained to identify audio signals from a game play referee such as “player 202 was sacked at the line of scrimmage, second down”.

In some embodiment, at Step 820 the method may be configured to utilize the output of the analysis of the movement of player at Step 816 and the output of the analysis of the signals of the game at Step 818 to perform an output analysis, for example the outputs may be compared as an error check. In some embodiments an output of from the analysis of movement may be “player 202 passed the ball to player 204, player 210 tackled player 204, seven-yard pass completed, 2^{nd} down”, and an output from the analysis of signals may be “player 204 receives the pass for a seven yard gain”. In some embodiments, the method at Step 820 may be configured to compare these outputs utilizing a distance measure such as k-means algorithm, a clustering algorithm, or a similar algorithm that may determine the similarity of a numerically transformed vector of the outputs.

In some embodiments at Step 822 the method completes the analysis with the aforementioned artificial intelligence algorithms and determined for example player 202 passed the ball to player 204, player 210 tackled player 204, seven-yard pass completed, 2^{nd} down, the method then sends this information to a user computing device and the information is populated in the GUI of an application.

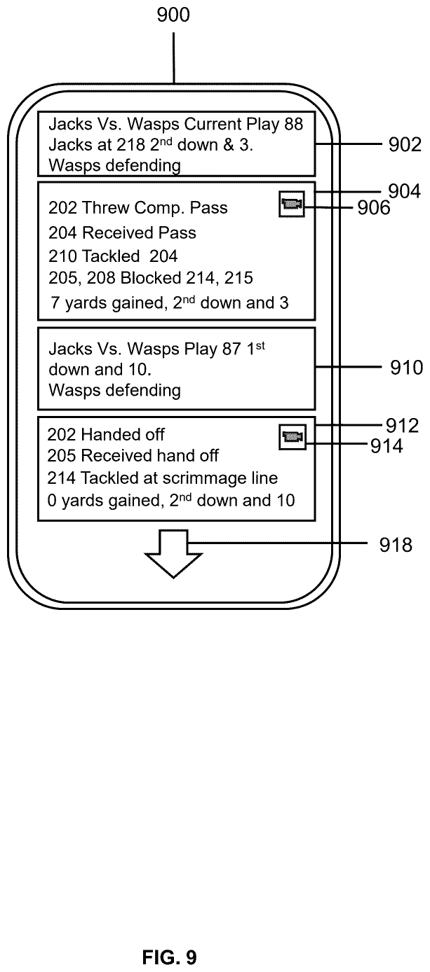

FIG. 9 is perspective view of an output of the determined play on a game play space displayed on a computing device according to one embodiment of the disclosure.

In some embodiments a user device 900 may be configured to run an application that receives the determined play on a game play space 102. The application may, as shown in FIG. 9, have a series of boxes that display information about the current state of play and previous state of play on the game play space.

In some embodiments box 902 may be configured to display the names of the teams Jacks Vs. Wasps and the current play number, which is play number 88. Box 902 also displays which team possession and location of the play, jacks at marker 218 2^{nd} down & 3, and that the wasps are defending.

In some embodiments, box 904 may be configured to display the details of the determined state of play generated by analyze engine 706, such as, player 202 threw a completed pass, player 204 received the pass, player 210 tackled player 204, player 204 and player 205 blocked players 214 and 215, and seven yards were gained, the play is now 2^{nd} down and 3 yards to go.

In some embodiments, video button 906 may be configured in box 904. Video button 906 may be configured as a link to an image, and/or a series of images of the state of play collected by a game play device associated with box 902 current play. In some embodiments, a user pressing video button 906, the user is presented with an image and/or a series of images associated with the state of play within an image playback box in the application.

In some embodiments box 910 displays the state of play determined by analysis engine 706, from the previous play, in this instance play 87 precedes play 88 of box 902. Box 910 shows the current play Jacks Vs. Wasps, play 87, 1^{st} down and 10, Wasps defending. In some embodiments, box 910 may include more or less information about the statistics in the game, such as leading rusher, or yards completed during passing, and the disclosure is not limited to any particular type of information about the state of play of the game.

In some embodiments, box 912 displays the determined state of play by analysis engine 706 from the previous play, player 202 handed the ball off to player 205, player 205 was then tackled by player 214 at the line of scrimmage, 0 yards gained, 2^{nd} down and 10 yards to go. In some embodiments, video button 914 may be configured in box 912. Video button 914 may be configured as a link to an image, and/or a series of images of the state of play collected by a game play device associated with box 912 previous play. In some embodiments, a user pressing video button 912, the user is presented with an image and/or a series of images associate with the state of play within an image playback box in the application.

In some embodiments, a user of the application is capable of scrolling through a series of boxes such as box 902 and 904 that contain information about the state of game play, in some embodiments the application may be configured with arrow 918 that allows the user to scroll down to the previous play. In other embodiments, the application may be configured to scroll down by the action of a user swiping up or down on a touch sensitive enabled display of the computing device.

In some embodiments the present disclosure makes reference to a computing device(s), however, the disclosure is not limited as such and may utilize application specific integrated circuit (ASIC), or graphics processing unit (GPU), or any similar architecture or any combination thereof, computing devices for carrying out the system and method of the disclosure may be utilized on premise or as a remote client, such as for example a cloud client or any combination thereof for example some or parts of the processing may be performed locally on a computing device, and some processing may be performed on a cloud client and/or remote client.

In some embodiments the system and method of the disclosure make reference to artificial intelligence algorithms such as for example YOLO (real-time object detection), SSD (single shot detection) RetinaNet (focal loss detection), Faster R-CNN (two-stage detection), Mask R-CNN (instance segmentation), Cascade R-CNN (progressive refinement), Focal Loss (dense object detection), MobileNetV2 (efficient mobile detection), Single Shot MultiBox Detector (real-time multi-scale detection), YOLOv3 (incremental improvement), YOLO 9000, Mobile Nets, YOLOv4, however it is not limited as such as any artificial intelligence algorithm can be utilized to carry out the system and method of the disclosure. As referred to herein an artificial intelligence algorithm is an algorithm that has a general architecture of layers of nodes that determine how the model processes data, extracts features, and makes predictions such as in the form of an input layer for receiving an input, i.e., an image or series of images or audio signals, a middle layer (i.e., hidden layer) an output layer, a loss function and a back propagation algorithm. In some embodiments the system and method of the disclosure may be configured to utilize a convolution neural network, or a recurrent neural network to make predictions about images, a series of images, and/or it may utilize generative models such as generative adversarial neural networks and/or variational autoencoders or any combination thereof.

In some embodiments the system and method may be configured to select one or more artificial intelligence algorithms for determining game play of a player on the game play space 102. One skilled in the art will understand that selection of an artificial intelligence algorithm can depend on many factors for example, data quality, image quality, data transmission quality and/or network quality, these factors are among many factors that can change the accuracy of prediction of game play for a given AI algorithm. In some embodiments a selected artificial intelligence algorithm may be configured as a convolution algorithm (convolution neural network, or CNN), have fully connected operations, and pooling.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules and/or engines. Software components of a module may be stored on a computer-readable medium for execution by a processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than, all the features described herein are possible.

Functionality may also be, in whole or in part, distributed among multiple components, in manners now known or to become known. Thus, myriad software/hardware/firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

With the foregoing description, the disclosure herein has described the subject matter of the following numbered clauses:
Clause 1. A method of determining game play including identifying, with at least one processor, at least one player on a game play space, determining, with the at least one processor, the movement of the at least one player on the game play space, analyzing, with the at least one processor, utilizing an artificial intelligence algorithm, the determined movement of the at least one player on the game play space, determining, with the at least one processor, based on the analyzing, the at least one player game play on the game play space, outputting, with the at least one processor, the at least one player determined game play to a device.

Clause 2. The method of clause 1, the identifying the at least one player in at least one image from at least one image device.

Clause 3. The method of clause 2, the identifying the at least one player, the at least one image a 360 degree image of the game play space.

Clause 4. The method of clause 2, the identifying the at least one player, the at least one image device positioned in an opposing position on a game play space.

Clause 5. The method of clause 1, the identifying the at least one player by at least one identifier affixed to the at least one player.

Clause 6. The method of clause 1, the determining the at least one player game play a game play statistic related to the at least one player.

Clause 7. The method of claim 1, the analyzing the determined movement further including, analyzing, utilizing a large language model, at least one game play audio signal to determine a movement of the at least one player game play.

Clause 8. An apparatus for determining game play including, a processor and a storage medium for tangibly storing thereon program logic for execution by the processor, the stored program logic causing the processor to perform the operations of identifying, at least one player on a game play space, determining, the movement of the at least one identified player on the game play space, analyzing, utilizing an artificial intelligence algorithm, the determined movement of the at least one identified player on the game play space, determining, based on the analyzing, the at least one player game play on the game play space, outputting, the at least one player game play to a device.

Clause 9. The apparatus of clause 8, the identifying the at least one player in at least one image from at least one image device.

Clause 10. The apparatus of clause 9, the identifying the at least one player, the at least one image a 360 degree image of the game play space.

Clause 11. The apparatus of clause 9, the identifying the at least one player, the at least one image device positioned in an opposing position on a game play space.

Clause 12. The apparatus of clause 8, the identifying the at least one player by at least one identifier affixed to the at least one player.

Clause 13. The apparatus of clause 8, the determining the at least one player game play a game play statistic related to the at least one player.

Clause 14. The apparatus of clause 8, the analyzing the determined movement further including, analyzing at least one game play audio signal utilizing a large language model to determine a movement of the at least one player game play.

Clause 15. A non-transitory computer readable storage medium for tangibly storing computer program instructions capable of being executed by a computer processor, the computer program instructions defining the steps of identifying, at least one player on a game play space, determining, the movement of the at least one identified player on the game play space, analyzing, utilizing an artificial intelligence algorithm, the determined movement of the at least one identified player on the game play space, determining, based on the analyzing, the at least one player game play on the game play space, outputting, the at least one player game play to a device.

Clause 16. The computer readable storage medium of clause 15, the identifying the at least one player in at least one image from at least one image device.

Clause 17. The computer readable storage medium of clause 16, the identifying the at least one player, the at least one image a 360 degree image of the game play space.

Clause 18. The computer readable storage medium of clause 16, the identifying the at least one player, the at least one image device positioned in an opposing position on a game play space.

Clause 19. The computer readable storage medium of clause 15, the identifying the at least one player by at least one identifier affixed to the at least one player.

Clause 20. The computer readable storage medium of clause 15, the determining the at least one player game play a game play statistic related to the at least one player.

1. A method of determining game play comprising:
identifying, with at least one processor, at least one player on a game play space;
determining, with the at least one processor, the movement of the at least one player on the game play space;
analyzing, with the at least one processor, utilizing an artificial intelligence algorithm, the determined movement of the at least one player on the game play space;
determining, with the at least one processor, based on the analyzing, the at least one player game play on the game play space;
outputting, with the at least one processor, the at least one player determined game play to a device.

2. The method of claim 1, the identifying the at least one player in at least one image from at least one image device.

3. The method of claim 2, the identifying the at least one player, the at least one image a 360 degree image of the game play space.

4. The method of claim 2, the identifying the at least one player, the at least one image device positioned in an opposing position on a game play space.

5. The method of claim 1, the identifying the at least one player by at least one identifier affixed to the at least one player.

6. The method of claim 1, the determining the at least one player game play a game play statistic related to the at least one player.

7. The method of claim 1, the analyzing the determined movement further comprising: analyzing, utilizing at least one large language model, at least one game play audio signal to determine a movement of the at least one player game play.

8. An apparatus for determining game play comprising: a processor; and a storage medium for tangibly storing thereon program logic for execution by the processor, the stored program logic causing the processor to perform the operations of:
identifying, at least one player on a game play space;
determining, the movement of the at least one identified player on the game play space;
analyzing, utilizing an artificial intelligence algorithm, the determined movement of the at least one identified player on the game play space;
determining, based on the analyzing, the at least one player game play on the game play space;
outputting, the at least one player game play to a device.

9. The apparatus of claim 8, the identifying the at least one player in at least one image from at least one image device.

10. The apparatus of claim 9, the identifying the at least one player, the at least one image a 360 degree image of the game play space.

11. The apparatus of claim 9, the identifying the at least one player, the at least one image device positioned in an opposing position on a game play space.

12. The apparatus of claim 8, the identifying the at least one player by at least one identifier affixed to the at least one player.

13. The apparatus of claim 8, the determining the at least one player game play a game play statistic related to the at least one player.

14. The apparatus of claim 8, the analyzing the determined movement further comprising: analyzing, utilizing at least one large language model, at least one game play audio signal to determine a movement of the at least one player game play.

15. A non-transitory computer readable storage medium for tangibly storing computer program instructions capable of being executed by a computer processor, the computer program instructions defining the steps of:
identifying, at least one player on a game play space;
determining, the movement of the at least one identified player on the game play space;
analyzing, utilizing an artificial intelligence algorithm, the determined movement of the at least one identified player on the game play space;
determining, based on the analyzing, the at least one player game play on the game play space;
outputting, the at least one player game play to a device.

16. The computer readable storage medium of claim 15, the identifying the at least one player in at least one image from at least one image device.

17. The computer readable storage medium of claim 16, the identifying the at least one player, the at least one image a 360 degree image of the game play space.

18. The computer readable storage medium of claim 16, the identifying the at least one player, the at least one image device positioned in an opposing position on a game play space.

19. The computer readable storage medium of claim 15, the identifying the at least one player by at least one identifier affixed to the at least one player.

20. The computer readable storage medium of claim 15, the determining the at least one player game play a game play statistic related to the at least one player.
